(19) United States
(12) Patent Application Publication
(10) Pub. No.: US 2010/0172136 A1
(43) Pub. Date: Jul. 8, 2010

(54) Compact non-lethal optical disruption device

(76) Inventors: Robert S. Williamson, III, Middleton, WI (US); Mark C. Shults, Madison, WI (US); Thomas M. Klos, Madison, WI (US); David G. Barton, Madison, WI (US); Yajun Lu, Sun Prairie, WI (US)

Correspondence Address: LUMEN PATENT FIRM, 350 Cambridge Avenue, Suite 100, PALO ALTO, CA, 94306, US

(21) Appl. No.: 12/592,067

(22) Filed: Nov. 17, 2009

Related U.S. Application Data
(60) Provisional application No. 61/199,582, filed on Nov. 17, 2008.

(51) Int. Cl. G02B 27/20; F21S 8/10; F21V 5/00; G02B 27/28

(52) U.S. Cl. 362/259; 362/317; 362/326; 359/495

(57) ABSTRACT

The current invention provides an optical disruptor having a laser system, a rangefinder, where the rangefinder provides a real-time distance to a target, control electronics; and dynamically-controlled output optics. The dynamically-controlled output optics are actuated by the control electronics to provide a divergence in real-time of an output of the laser system, where the real-time divergence is according to the real-time distance to the target.

### CROSS-REFERENCE TO RELATED APPLICATIONS

This application is cross-referenced to and claims the benefit from U.S. Provisional Application 61/199,582 filed Nov. 17, 2008, and which are hereby incorporated by reference.

### FIELD OF THE INVENTION

The present invention relates generally laser-based illumination devices. More particularly, the invention relates to a non-lethal laser illumination device that operates over a wide environmental temperature range and includes automatic divergence control according to a distance provided by a range finder.

### BACKGROUND

Non-lethal optical distraction devices are more becoming common in applications that include: dazzling or optical disruption of an assailant, target or battlefield illumination, in vehicle-mounted (truck, car, airplane, ground robot, UAV) scenarios, crowd control, vehicle checkpoints, convoy security, or suppression of combatants or non-combatants. These diverse applications require a reliable and rugged optical disruption device having built-in safeguards to not cause any long-term damage to the eyes when used. The problem with a standard non-lethal optical disrupter and any other high power laser illuminator is the presence of a nominal ocular hazard distance (NOHD). Below this distance, the exposure to the light emitted by the laser can lead to irreversible damage of the eye. The operator of the laser has to make a decision on his own, if the target is beyond the NOHD. Irreversible damage to a target person's vision by using the device unintentionally in shorter distances then the NOHD is possible.

Furthermore the current state of the art does not provide a reliable and compact optical system, where such systems may include expensive and lossy fiber optic couplings with lengthy beam paths. The fiber optic coupling is known to be a system failure point, due to the precision and sensitive alignment of the fiber output coupled to the laser medium.

What is needed is a non-lethal optical disruptor device that provides a real-time output adjustment according to a measured distance to a target. What is further needed is an optical disruptor device that reduces the beam path from a pump laser to the solid-state laser medium with increased efficiency and ruggedness at a reduced cost and form factor.

### SUMMARY OF THE INVENTION

The present invention provides an optical disruptor having a laser system, a rangefinder, where the rangefinder provides a real-time distance to a target, control electronics; and dynamically-controlled output optics. The dynamically-controlled output optics are actuated by the control electronics to provide a divergence in real-time of an output of the laser system, where the real-time divergence is according to the real-time distance to the target.

According to one aspect of the invention, the laser system includes at least two wavelength-stabilized pump laser diodes having laser diode outputs directed through free-space delivery optics to pump a solid-state laser medium to generate the laser system output. Here, the free-space delivery optics include a birefringent crystal that receives a first pump beam along an axis of the laser system output and receives a second pump beam parallel to the first pump beam, where the first pump beam has a first polarization and the second pump beam has a second polarization, and the second polarization is disposed to converge the second pump beam to the first pump beam as the pump beams traverse the birefringent crystal. According to one aspect of this embodiment, the birefringent crystal can include calcite, YVO₄ (vanadate), crystalline quartz, and LiNbO₃ (lithium niobate), MgF₂, sapphire (Al₂O₃), or zircon (ZrSiO₄). In another aspect of the current embodiment, the free-space delivery optics includes an optical retarder disposed along a beam path of the second diode pump laser and between the second diode pump laser and the birefringent crystal. In another aspect, the free-space delivery optics further includes a first converging lens disposed between the first diode pump laser and the birefringent crystal and a second converging lens disposed between the second diode pump laser and the birefringent crystal. In a further aspect, a converging lens is disposed between the birefringent crystal and the solid-state laser medium.

According to one aspect of the invention, the free-space delivery optics includes a polarizing beam splitter that receives a first pump beam along an axis of the solid-state laser medium and receives a second pump beam at an angle normal to the solid-state laser medium, where the first pump beam has a first polarization and the second pump beam has a second polarization. Here, a first converging lens is disposed between the first diode pump laser and the polarizing beam splitter and a second converging lens is disposed between the second diode pump laser and the polarizing beam splitter.

In another aspect of the invention, the free-space delivery optics have a first converging lens disposed in a beam path of a first diode pump laser, a second converging lens disposed in a beam path of a second diode pump laser, a third converging lens disposed between the converging lenses and the solid-state laser medium and disposed between the second converging lens and the solid state laser medium.

According to another aspect the free-space delivery optics includes a first converging lens disposed along a beam path of a first the diode pump laser and between the first diode pump laser and the solid-state laser medium, and further comprising a second converging lens disposed along a beam path of a second the diode pump laser and between the second diode pump laser and the solid-state laser medium, wherein the first diode pump laser beam path is disposed normal to the solid-state laser medium and the second diode pump laser beam path is disposed normal to the solid-state laser medium.

In a further aspect of the invention, the dynamically controlled output optics includes at least one electrically-variable or liquid lens, wherein the electrically-variable or liquid lens adjusts said divergence of said laser system output.

According to another aspect the controller electronics includes a switching buck regulator, and a switching current source and temperature switching circuit.

In one aspect, the control electronics have an optical output regulator.

In yet another aspect, the optical disruptor is battery-powered.

In a further aspect, the solid-state laser medium can include Nd:YVO₄ (vanadate), Nd:YAG, Yb:YAG, or Nd:YGdO₄.

In yet another aspect, an output from the solid-state laser medium is frequency multiplied using a frequency multiplying medium such as KTP, KTA, KDP, KD*P, LN, LT, BBO, BIBO, cPPLN, sPPLN, cPPLT, or sPPLT (or any of their Mg-doped equivalents).

In one aspect the laser system output is a pulsed mode or a continuous-wave mode.

According to another aspect of the invention, the laser system includes an operating temperature over a range of −20° C. to 60° C.

In a further aspect, current is provided to at least one the pump laser diode at all times during operation of the laser system.

According to one aspect the pump laser diodes are controlled according to a condition of the laser system output, where the laser output condition is sampled and fed back to the controller by an optical sampler and feed backloop.

### BRIEF DESCRIPTION OF THE FIGURES

The objectives and advantages of the present invention will be understood by reading the following detailed description in conjunction with the drawing, in which:

FIG. 1 shows a system diagram of one embodiment of the invention having two wavelength-stabilized pump lasers and two apertures. Shown in dashed boxes are the electrical circuit elements, solid lined boxes are optical elements according to the current invention.

FIG. 2 shows sample performance data of the system operating at or above 450 mW and from −20 to +60° C. according to the current invention.

FIG. 3a shows a schematic of architecture for integrating dynamic range finding into a non-lethal optical disruptor according to the current invention.

FIG. 3b shows the control electronics according to the current invention.

FIG. 4 shows a schematic having further detail of architecture for integrating dynamic range finding into a non-lethal optical disruptor according to the current invention.

FIG. 5a shows range performance of a typical fixed divergence, fixed output power device without range finding capability and an M² of 1 according to the current invention. The NOHD of this device is set to 20 m. The resulting effective range is limited by the decreasing intensity of the beam.

FIG. 5b shows range performance of a variable power, fixed divergence device with range finding capability according to the current invention. This device has an NOHD of 2 meters.

FIG. 6a shows range performance of a fixed power, variable zoom (10× zoom range) with range finding capability according to the current invention. This device is tuned to have an NOHD of 20 meters.

FIG. 6b shows range performance of a variable power, variable zoom (10× zoom range) with range finding capability. This device is tuned to have an NOHD of 2 meters according to the current invention.

FIG. 7 shows a performance graph of a system integrating a rangefinder and moderate-power green DPSS laser according to the current invention.

FIG. 8 shows a block diagram of a long-distance rangefinder integration according to the current invention.

FIG. 9 shows the elements of a packaged embodiment according to the current invention.

FIG. 10 shows the intensity on a target as a function of distance and the spot diameter for a fixed divergence beam with adjustable output power according to the current invention.

FIGS. 11a-f show different beam diameters/power at different distances locations, according to the current invention.

FIG. 12 shows how accelerations in angle change turn off the laser or set to minimum NOHD for rapid angle changes by providing an acceleration or gyroscope sensor according to the current invention.

FIGS. 13a-f show compact and rugged free-space delivery optics according to the current invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

In one aspect, the current invention includes a portable, eye-safe laser that is usable over a range of extreme environmental conditions, such as a wide range of earth surface temperatures ranging from arctic to desert. Further, the current invention is capable of delivering a constant reliable output optical power with high efficiency. Green laser light at 532 nm is near the peak of the human sensitivity (555 nm), and when delivered to the eye with an intensity of less than or equal to 1.0 Mw/cm² for up to 10 seconds, or 2.55 mW/cm² for less than 0.025 seconds is considered eye-safe with no damage, retinal or otherwise, by ANSI Z136.1 standards. Accordingly, one embodiment, the invention provides a momentary disabling of disruption of the vision of a human target by overwhelming their visual sense with a flood of laser light having an intensity that is well above the ambient lighting level. In one aspect of the invention, the laser may pulse on and off in a pattern that is further disruptive to the assailant. In another aspect of the invention, at long distances from the device where the beam is larger in diameter and the intensity delivered to the eye is lower, the impact is lower but still provides a compelling warning signal and potentially disabling the ability to look into the laser beam, reducing the ability to perform a task, such as driving for example. The invention is useful for preventing or delaying the use of lethal force by stopping or warning a potential assailant.

The present invention combines wavelength-stabilized laser diodes, automatic optical power control, and rapid switching among the pump laser diodes to achieve simultaneously high optical output power, high efficiency (and long battery lifetime), and wide operating temperature range. In one embodiment, these are provided in a lightweight, portable, highly integrated, ruggedized, battery-powered package that includes an optical telescope to control the divergence in real-time according to a distance measured by a range finder, and an integral elevation and azimuth adjustment. The highly efficient device functions on battery power. In one embodiment, the battery life of the device in operation can exceed 2 hours at room temperature and 1 hour at the temperature extremes.

Solid-state lasers generally require an optical pump source that can match the atomic absorption transition defined by the rare earth dopant. The atomic emission transition is independent of pump wavelength and of temperature, making this laser architecture ideal in that it produces a stable laser output wavelength. However, all crystals require that the exciting pump source wavelength be thermally stable, sufficient to enable efficient absorption by the crystal. Variation in the pump laser wavelength leads to varying output power and efficiency and ultimately limits the operating temperature range and output power. The current invention provides a laser architecture that combines multiple internally-wavelength-stabilized pump laser diode sources, design-specific electronics, control loop, and carefully selected laser crystals that serve to provide an extremely wide temperature range of operation with high efficiency and output power. In one embodiment, the invention uses multiple high-efficiency diode lasers that are turned on only when they are in resonance with (absorbed by) the solid-state crystal. According to one embodiment, the invention can deliver over 500 mW of visible green laser light, for example at 532 nm, over an operating temperature range beyond −20° C. to +60° C. and requires no active cooling. In one aspect of the present invention a diode-pumped-solid-state laser is used to achieve the desired optical effect from a range of below 20 meters to beyond 1 km.

According to one embodiment, by combining temperature monitoring and the ability to switch the diodes on and off as the temperature changes, the system efficiency is optimized and the battery life is extended. In one aspect, the device is integrated with a “make before break” FET switching scheme, and an optical automatic power control ensures that the laser's output power is constant as the diodes switch on and off. The use of a hysteretic switch architecture with a finite temperature window ensures the two diodes do not switch repeatedly as they warm themselves through normal operation or due to environmental temperature changes.

In another embodiment of the invention, the packaging is ergonomic, user-friendly and well-integrated with a weapon system to which it can be mounted. In one aspect, the invention integrates a battery-powered diode-pumped visible solid-state laser into a compact, lightweight housing that can also serve as a foregrip on a longarm weapon. The device is capable of surviving mechanical shock, vibration, and a wide range of environmental trauma as per MIL-STD-810-G requirements.

In another embodiment, the invention combines several electrical and optical elements in a seamless fashion to provide wide operating temperature range, high efficiency, and seamless continuous-wave operation. Some exemplary elements include wavelength-stabilized pump laser diodes, where each diode stays within atomically-defined (and therefore temperature insensitive) absorption bands over a range that is 30 to 50° C. wide, where some exemplary ranges are 10° C.-40° C., 0° C.-50° C. or −20-20° C. Further, the use of two or more of these wavelength-stabilized pump diodes arranged with adjacent temperature locking ranges and identical center wavelengths allows the operating temperature range to grow arbitrarily broad by adding more laser diodes. Another element includes the use of a multiplicity of individual or optically combined pumping apertures delivered to the solid-state laser crystal in a manner that delivers multiple, closely spaced output beams. This arrangement allows for a scaling of output power without thermally loading the optical crystal. Modified buck (or boost or buck-boost) conversion power supply circuitry (or integrated IC) is used, where they are modified using a current sense means and a transconductance amplifier to supply a constant current. This circuitry also integrates a precision maximum current limit to protect the laser diodes from overdrive conditions. This provides a very highly efficient, current-controlled supply from a portable, battery-based power source. Further provided is a seamless thermal crossover/switching circuitry to turn one pump laser off and another on as the ambient or system temperature changes. The crossover/switching circuitry performs this task while maintaining constant output power using optical APC (automatic power control).

In another embodiment of the invention, a laser system is integrated into a compact package to produce a lightweight and ergonomic design. Some of these aspects can include an integrated fixed telescope to control the output beam divergence of the laser, integrated azimuth-elevation adjusters to boresight the beam to a longarm weapon or optical sight, embedded lever-action quick-release for mounting to a MIL-STD-1913 Picatinny rail, package shape, design, and dimensions that accommodate the size of a typical hand and include finger swelts to ensure both gloved and ungloved hands are naturally led to the actuation switch and a comfortable overall grip. The invention may further include a domed, sealed, positive-actuation activation switch, a rotary enable/disable switch for safety and a remote tape switch jack compatible with wide range of available tape switch or other types of switch.

According to one embodiment, the architecture can be extended to include an integrated rangefinder, variable power, divergence and/or zoom control that allows the delivery of a high-level of constant optical intensity to the target regardless of its distance from the invention over a range, for example from less than 2 meters to exceeding 200 meters. In one aspect the current embodiment can include decreasing intensity beyond 200 meters to over a kilometer and still deliver a high level of useful optical irradiance (capable of distracting, disorienting, or incapacitating).

According to one embodiment of the invention the laser crystal assembly (LCA) can include a rare-earth doped crystal, cavity mirrors, and an optional frequency multiplying element, for example a doubling element. In one aspect, the LCA can include Nd:YVO₄ (vanadate) and KTP, with integrated coated mirrors. Other laser crystals include Nd:YAG or Yb:YAG where the YAG is a crystal or a ceramic; Nd:YGdO₄, Nd:GGG, Nd:YLF, Er:glass, or Yb:glass, but are not limited this list alone. In other aspects, the KTP may be removed (no doubling medium), or replaced with KDP, KTA, KD*P, LN, LT, BBO, BIBO; cPPLN, sPPLN, cPPLT, sPPLT (or any of their Mg-doped equivalents) but are not limited to this list alone.

According to another aspect, the invention can include one or more pump delivery apertures, or free-space delivery optics, for delivering pump power to the crystal. In the case of one aperture, the invention must include an element for combining the pump outputs, for instance: a tapered fiber bundle (TFB), a polarizing beam splitter, a birefringent separating crystal such as calcite, YVO₄, crystal quartz, or LiNbO₃, or an arrangement of lenses to perform spatial beam combining.

According to another aspect, invention includes at least two pump laser diodes with wavelength-stabilized output. The temperature range over which the output of each pump diode remains stable must be distinct, however the locking ranges may overlap or have a gap between them. This can be extended to more laser diodes to cover an arbitrarily large operating temperature range, limited only by the combining methods (if used) and complexity of the control electronics.

In one aspect the invention includes a circuit to switch the laser diodes on and off as the temperature changes, and a sense element to sense the temperature of the diodes. The circuit may keep the current in one or more diodes flowing at all times, even during the switching period, which may require two diodes to operate simultaneously momentarily. In another embodiment, the circuit allows both pumps to be off for a brief moment, short enough that it is undetectable by the human eye (e.g., less than 20 milliseconds).

The invention further includes a circuit to control the laser current in order to maintain the optical output power, especially as the circuit switches from one diode to the other. One method to achieve this includes an element to monitor the optical output power of the laser.

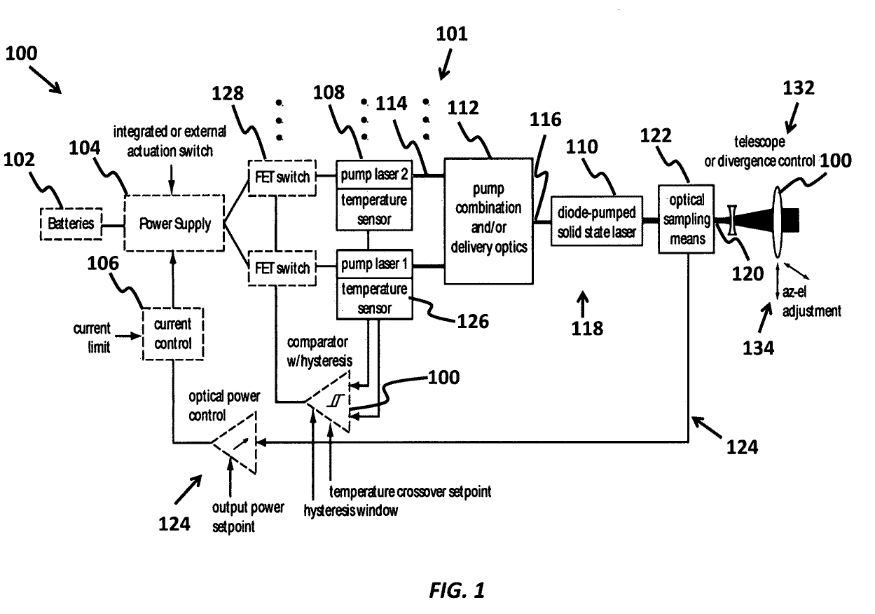

In one exemplary implementation, FIG. 1 shows a system diagram 100 of one embodiment of the invention that includes a laser system 101. Batteries 102, for example, 3-volt lithium CR123A batteries, provide the source power. A power supply circuit 104 provides a regulated voltage. A separate op amp and current sense resistor provides feedback to the buck converter to allow it to provide a controlled (or constant) current 106 to the laser diodes 108.

The pump laser output 114 from the pump laser diodes 108 is delivered to the diode-pumped solid-state (DPSS) laser crystal 110 via delivery optics 112 for providing an optically combined or geometrically adjacent pump laser source 116. For example, the delivery optics 112 may deliver the pump light 116 into a single or multiple apertures.

The DPSS crystal assembly 110, as described above, converts the pump light 116 into the output laser light 120. In this example, the DPSS 110 can include an optically contacted or bonded set of Nd:YVO₄ and KTP crystals, but nearly any mirror/(rare earth):(host crystal)/mirror or mirror/(rare earth):(host crystal)/(doubling medium)/mirror or mirror/(rare earth):(host crystal)/(high transparency optical substrate)/(doubling medium)/mirror may be used. According to one embodiment, the output wavelength is 532 nm. Other embodiments may include wavelengths that range from 150 nm to 8000 nm, depending on the gain medium, doubling crystal, and other laser cavity optical elements.

The output laser light 120 can be captured by an optical sampler 122, for example a piece of glass, coated or uncoated, that reflects a small amount of the light. The reflected light can be captured by an optical photodiode or other photosensitive material, and an optical power output signal provided to the power supply 104 via an optical power feedback channel 124, which controls the current to the pump diodes 108 in order that the output power is held constant over varying time, temperature, and battery charge state. In one example a proportional-integral-derivative (PID) loop with appropriately chosen constants is used. A P, PI, or PD may also be sufficient in different implementations, as may designs implementing feed-forward control approaches. Additional circuitry is integrated to limit the drive current to a precise fixed maximum current to prevent damage to the laser diodes 108 as well as to turn them on quickly without overshoot or slow undershoot. This circuitry ensures that the laser crystal assembly (LCA) 118 provide nearly full power (>80% of setpoint) in less than a few milliseconds, important for this non-lethal application.

A separate circuit can monitor the temperature of the laser diodes, in this instance using thermistors 126 inside the laser diode 108 packages themselves. The circuit compares the diode temperature to a setpoint temperature, and switches, for example using a FET switch 128 to one or the other diode based on the difference in temperatures. The switching is done with hysteretic bias 128 (using, e.g., a hysteretic op amp) to prevent thermal oscillations that can cause the circuit to switch back and forth between pump lasers 108 as they cool down and heat up. FIG. 1 further shows telescoping optics 132 disposed to control the divergence of the output beam 120, where the telescoping optics can further include a windage-elevation angle adjuster 134.

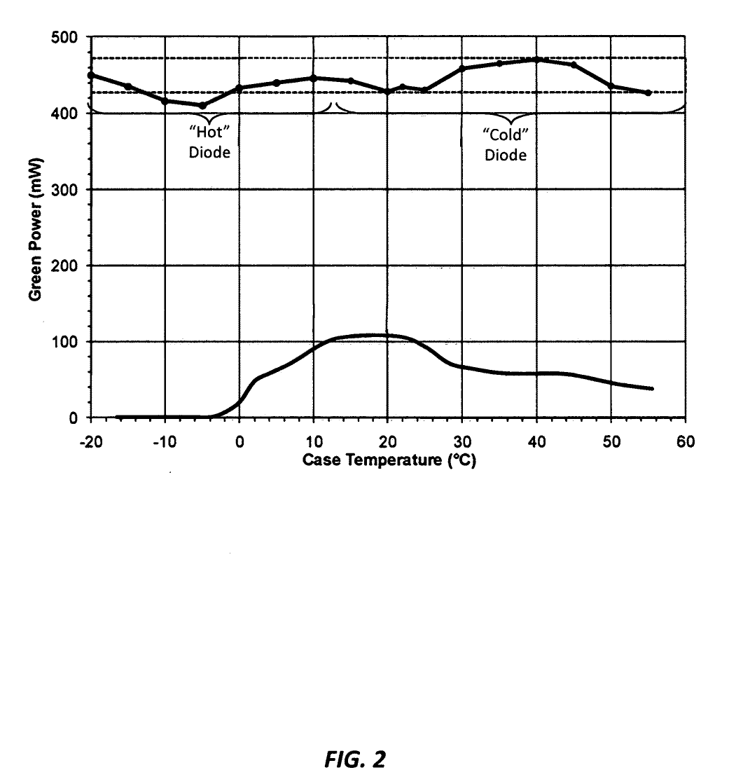

The resulting system performance over temperature 200 is shown in FIG. 2 below. The constant output power over temperature is shown in the solid line, where the laser system 101 operates at or above 400 mW and from −20 to +60° C., with a competing device data shown at the bottom. The power remains constant within ±8% over the entire operating range. As mentioned above, the invention can be extended to multiple laser diodes (>2) for wider temperature range, where the system operates without using a coupler for reduced cost. Further, the invention uses a combiner rather than a coupler to achieve single-output beam pointing stability and desired beam quality. The current invention is valid for any DPSS microcrystal assembly (e.g. KTPINd:YAG, KTPINd:YVO₄). This works for fundamental 1064 nm and doubled, tripled, or quadrupled frequency output. The architecture can work for a non-microcrystal DPSS laser as well, making it capable of higher power levels, where the pump source can be multiple wavelength-stabilized pump laser diodes in a single housing, which provide sufficient power (up to 30 watts) for pumping many types of DPSS laser assemblies.

In one embodiment, the entire system described in FIG. 1 can be housed in a compact, lightweight and rugged housing that is environmentally sealed and ruggedized. All of the mounting for the optical elements and electronics are done using methods that protect against shock and vibration. In a further aspect of the current embodiment, the device's ergonomic and usability features may include a sealed optical beam exit aperture (with protective flip-cap), integrated, compact, and sealed azimuth and elevation adjusters, a recessed firing pushbutton, a remote tape switch jack, a battery cap with integral rotary lockout switch, a lever-action quick-release mount (to MIL-STD-1913 rail) and/or an ergonomic comfort grip with finger swelts.

In order to extend the range of the output beam, the intensity at the target must be maintained over a wide range of distances. With a fixed divergence angle (and therefore fixed telescope) and output power, the intensity of the light decreases with distance. ANSI Z136.1 establishes a fixed safe intensity called the maximum permissible exposure (MPE) (2.55 mW/cm² for 0.25-second exposure or 1.0 mW/cm² for 10-second exposure, for most visible wavelengths including 532 nm). The minimum intensity in order to produce a usable distraction or warning varies based on the ambient environmental light (e.g., full noon time sun, sunset/sunrise, moonlight, starlight) and the desired impact (simply warn or fully disrupt vision). For maximum effect, the device according to the current invention delivers nearly the MPE from quite near the device to several hundred meters or kilometers.

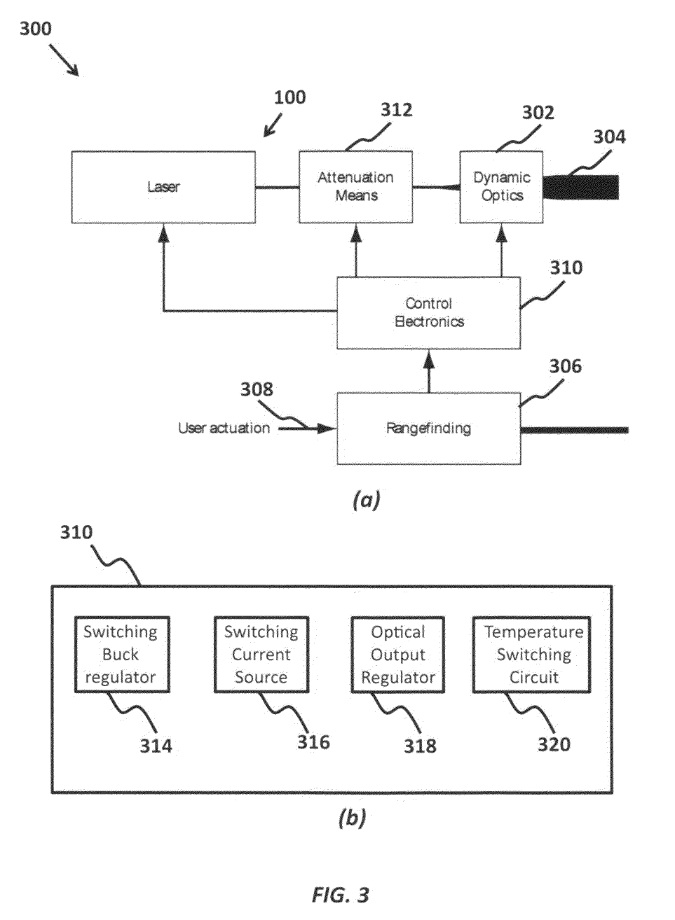

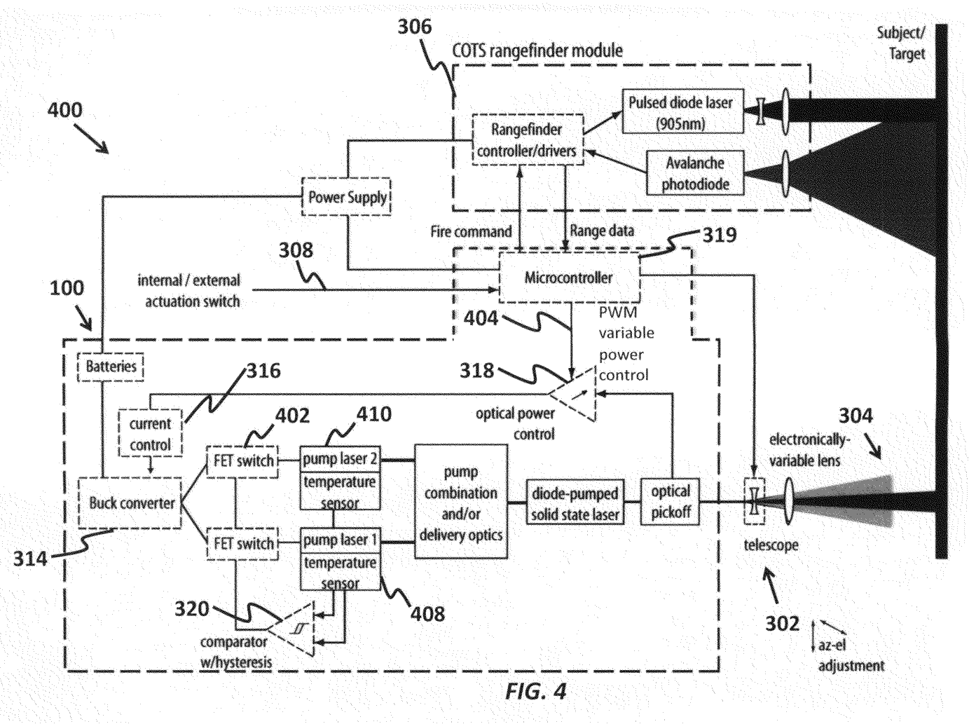

FIG. 3a shows an optical disruption device having real-time intensity adjustment 300, where the system 100 described above integrates dynamic optics 302 to control of the output beam 304 and a range finding mechanism 306 to achieve a wide operating range, where the MPE or a high fraction of the MPE (e.g. >1%) is delivered in the entire usable range. According to the current embodiment, a user activates the system 308, via a pushbutton or external switch, and the rangefinder 306 is activated to determine the distance to a target of interest. The rangefinder 306 may have a wavelength of 905, 920, 1064, 1550, 2000 nm wavelength or longer and be of a direct diode, diode-pumped solid-state, fiber laser or flashlamp-pumped. Control electronics 310 provide information from the range finder 306 relating to the range distance to the target of interest. The control electronics 310 vary the output power and/or divergence of the laser beam 304 to a safe level at or below the MPE. According to the current invention, the rangefinder 306, as further shown in FIG. 4, may include an acoustic sonar, which is usable for close operation, such as <20 meters, a time-of-flight laser pulse generator and detector (LADAR), where the laser used provides an eye-safe power level and the detector is a cooled or un-cooled photodiode or avalanche photodiode, and/or an interferometric laser and detector distance measuring system (LIDAR). Here it is understood that one or more of the rangefinders 306 can be integrated into the same package. In one aspect the rangefinder 306 may also be mounted externally and provide the distance information through a standardized interface.

FIG. 4 shows a further-detailed block diagram 400 of the system integrated with a rangefinder 306. The existing laser system 101 is integrated with a rangefinder and is combined with a variable lens/telescope and a controller 319, for example an 8-bit microcontroller. Upon the user firing the system, the microcontroller actuates the rangefinder and receives the range data; the range data is then used to adjust the telescope divergence and fire the NLOD laser. This sequence can occur in significantly less than 30 ms and continually adjusts the laser power and divergence according to the rangefinder reading to maintain an efficacious yet safe optical output beam.

The control electronics 310 provide a specified current regulated safe light output from the laser system 101. FIG. 3b shows the control electronics 310 having circuit sections to accomplish this purpose, which include a microcontroller 319, switching buck regulator 314, a switching current source 316, optical output regulation 318 and a temperature switching circuit 320. According to the current invention, the switching regulator 316 converts battery voltage at a low current to high laser current at a low voltage at an efficiency of about 90%. Here, as battery voltage decreases then current drain must increase to maintain constant power. The switching regulator as configured can operate from battery supplies ranging from 3 to 24 volts. The laser system 100 is normally off when shutdown and draws less than 10 microamps in this standby condition. A push button switch turns on the regulator 314 in about 1 millisecond. The switch also provides power to all other circuits.

The control electronics further include the current control feedback 316, where an op-amp and laser current sense resistor convert laser current to a voltage scaled to the needs of the regulator 314. In this example, the laser current sense resistor is only 10 milliohms to maximize circuit efficiency but its voltage is not adequate to drive the feedback of the voltage regulator 314. In another example the voltage across the laser diode, control FET, or inductors may serve to provide current feedback rather than the resistor, resulting in higher overall efficiency. The op-amp multiplies the laser current sense resistor voltage by 10 times to rescale current information to a useful voltage. This makes the voltage-based regulator a controlled current source. The feedback of the current regulator 314 is an external voltage reference, which in this circuit sets the maximum laser current. Additional RC elements provide frequency compensation for an error amp. In another example, the current control is accomplished using the microcontroller programmed to act as a P, PI, PD, or PID control loop based on sense current input from the laser diode.

Optical output control 318 is accomplished by applying a proportional integral derivative (PID) loop from a photodiode detecting, shown as an optical pickoff 402, a small portion of the optical output. The PID loop delivers a precision limited voltage to the external reference of the regulator 314 and vary the laser current to provide the right amount of light. Further shown is a rangefinder input 404 to the optical output control to provide the regulator 314 the required intensity information for a target at a particular distance.

Hot or cold lasers are operated depending on temperature. A temperature switching circuit 320 is provided, where in one embodiment the temperature switching circuit 320 includes a comparator to detect when a laser heatsink/temperature sensor 408 has passed a set temperature. Hysteresis of about ±1° C. is applied. FET switches 402 then turn on the correct laser. A gate series resistance provides switch turn off delay of about 100 microseconds, so both lasers will be on during any transition. This is important to avoid opening the current control loop of the switcher, which could result in pump laser 410 over-current condition. This forces the pump lasers 410 to share the current set by the last PID signal. Since the PID responds slowly, the 100 microsecond transition should not introduce a large transient although the change in pump laser 410 efficiency at the switching point will result in a PID correction over some several milliseconds. It is therefore desirable to set switchover near the cross-over of the efficiency curves.

Further shown in FIG. 3a is an attenuation element 312 that is optional. The attenuation element 312 can include one or more of the following elements such as a liquid crystal retarder and waveplates, a pair of positive optical lenses and a mechanical iris placed at an aperture stop, where the iris may alternatively be integrated into the dynamic optics at an aperture stop location, a linear or rotary gradient neutral-density filter with mechanical actuation, a linear optical polarizer and analyzer with mechanical actuation, adjustment of the current delivered to the pump diodes, a silica planar light guide variable optical attenuator, and/or a microfluidic variable light guide attenuator.

In a further aspect of the invention, the dynamic optics 302 can include one or more elements such as a mechanically actuated optical lens or set of lenses in a zoom magnification configuration, preferably a “rapid zoom” style mechanism or focusing mechanism; a fluidic or liquid-crystal optical lens, electrically or electro-mechanically actuated to achieve varying focal length; an optical lens or lenses that can be mechanically inserted or removed from the beam path; a diffractive optical element that can be mechanically inserted or removed from the beam path. According to the current invention, one of the attenuation elements 312 or dynamic optics 302 is provided in any one embodiment. Further, the laser system 101 has a fixed optical beam divergence and an electronic on/off input. Alternatively, this input allows for adjustment of the laser output power within a limited range, where for a diode-pumped solid-state laser without active thermal control this range is typically no wider than 10-120% of the nominal power.

In one embodiment, the rangefinder 306 and control electronics 310 are set to operate digitally. If the target is greater than a nominal ocular hazard distance (NOHD) then the attenuator/optics are not activated. If the target is closer than a NOHD then either a divergent lens or lens system disposed at the laser output is activated, the laser output is attenuated by a fixed amount using a fixed attenuator, the laser output power is reduced by reducing the pump current, or the laser output power is reduced by using pulse width modulation to reduce the average intensity, where the modulation rate must be greater than the time required to set up the thermal lens effect in the DPSS laser, but fast enough to be undetectable by a human, for example between 16 Hz and 1 kHz. The lower power or higher divergence angle would then define a closer NOHD, which becomes a redefined NOHD.

If desired, the rangefinder 306 could additionally be used to disable the unit entirely if the target comes closers than the NOHD.

In another aspect of the invention, the rangefinder 306 and control electronics 310 are set to operate in an analog or continuous fashion. This is similar to the embodiment described above, but the data from the rangefinder 306 is used to continuously vary the dynamic optics 302, such as a zoom lens or an electrically-variable lens, in addition to varying output power, or both. The control electronics 310, which may be analog or digital in nature, use the data from the rangefinder 306 to calculate the appropriate settings in the dynamic optics 302 to adjust the focal length of the lens or lenses to produce a constant intensity at the target.

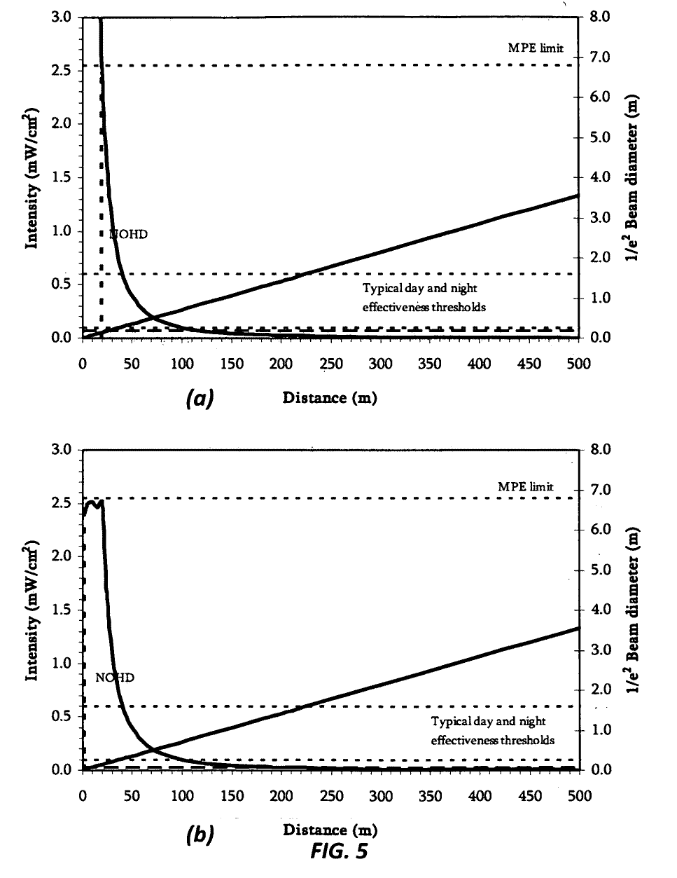

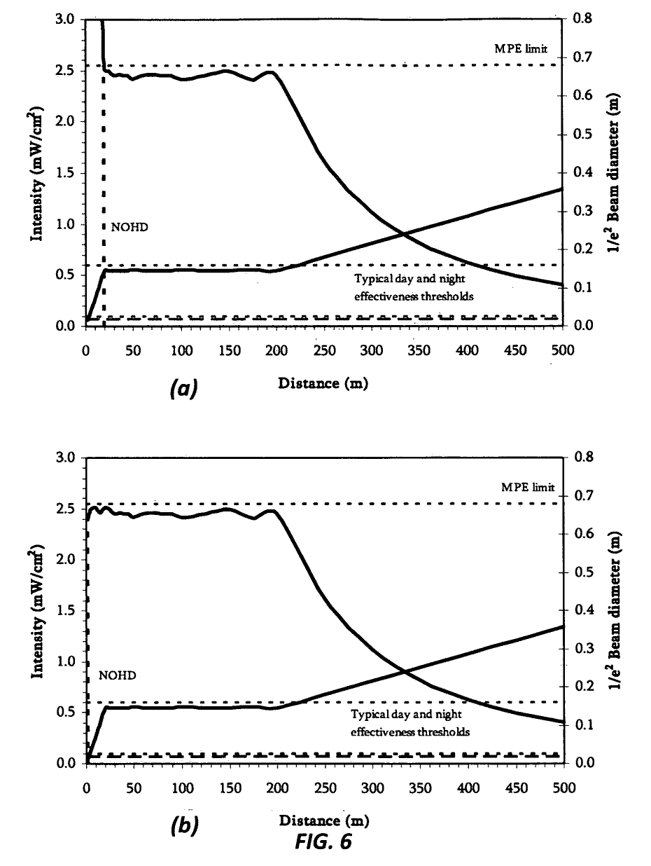

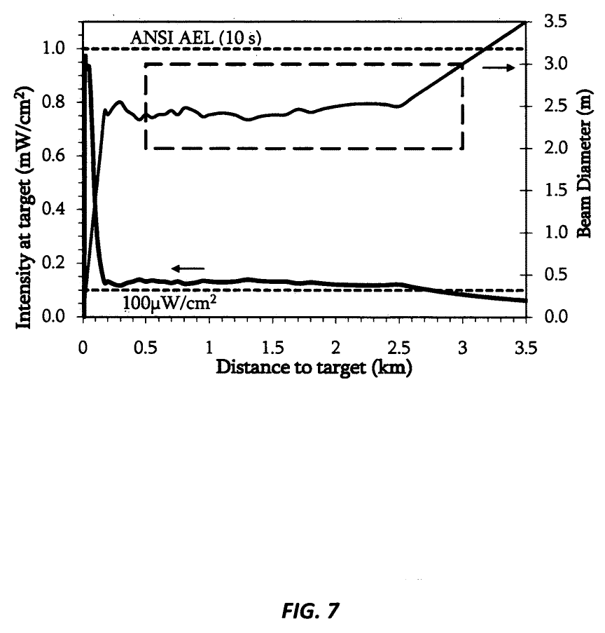

According to the current invention, there are many benefits afforded by rangefinding and various adjustment methods. FIG. 5a shows the performance of a device with fixed power and divergence; this device is tuned for 20 meter NOHD and has an M²=1, wherein it is shown that the device loses its effectiveness as a disruptor at approximately 100 meters. Conversely, the performance graph in FIG. 5b includes a device that adds rangefinding and variable power control to give the same range performance but decreases the safe NOHD down to 2 meters. In this configuration, the benefit afforded is solely a reduction in the NOHD but offers no improvement in the effective distance range of the device.

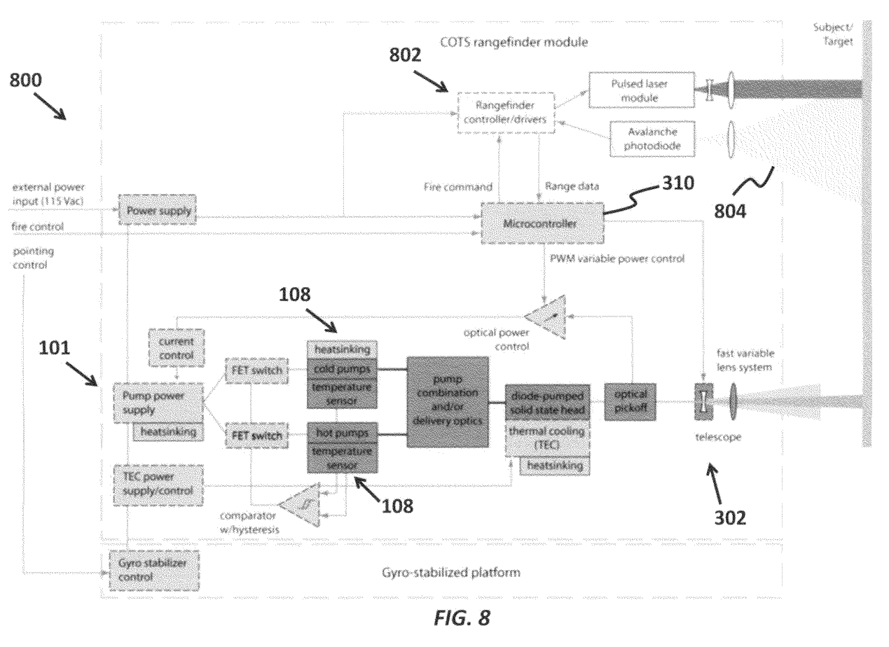

The performance graph in FIG. 6a includes adding variable divergence (in this example 10× variable divergence) that extends the usable range considerably, to beyond a kilometer. FIG. 6b shows the performance of a device with both variable divergence and variable power, giving the full benefits of a short NOHD of 2 meters and a usable range of a kilometer.

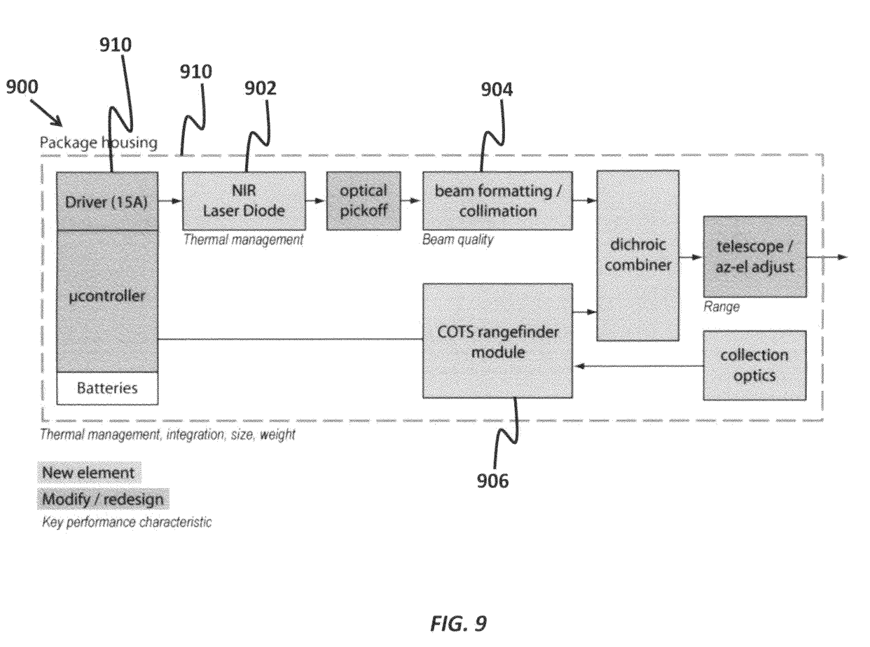

For a higher-power extended range non-lethal optical disruptor system, for example with ship-borne applications, the system uses longer distances and with more power and a larger spot size. FIG. 7 shows a performance graph of a system integrating a rangefinder and moderate-power green DPSS laser according to the current invention. The moderate-power green DPSS laser (6 watts) is capable of casting a roughly 2.5-meter diameter spot of light on a target beyond 3 km. Such a configuration may be scaled to a larger diameter spot of light or higher irradiance by scaling the power of the laser source. Such a method may also be applied to other types of laser or laser wavelengths.

FIG. 8 shows a block diagram of a long-distance rangefinder integration 800. The wavelength-stabilized diodes 108 pump a DPSS laser medium 110, which is combined with a variable lens/telescope 302, rangefinder 802, and microcontroller 310. Upon the user firing the system, the microcontroller 310 actuates the long-distance rangefinder 802 and receives the range data 804. The range data is then used to adjust the divergence of the telescope 302 and fire the laser system 101. According to the current invention, this sequence can occur in less than 30 ms, seamless and unapparent to the user, and can function continuously to dynamically adjust the beam and/or power while operating. This particular embodiment enables a higher-power system suitable for shipboard operation, and capable of covering an entire ship with a level of optical power sufficient to distract or disable the pilots of the remote ship.

With a required capability of reliably illuminating/exciting a target from a standoff distance of approximately 500 meters, the source must be man-portable, preferably weapon-mountable, and battery operated and therefore highly efficient. According to the current invention with 1 milliradian nominal divergence, the illuminated spot at 500 meters is approximately 0.5 meter in diameter. The intensity and operating mode of the source (CW or pulsed) is sufficient and compatible with the detection or imaging mechanism used to collect the light received back from the illuminating spot. Furthermore, in order to be deployed readily, the device meets established eye safety standards (ANSI Z136.1).

FIG. 9 shows the elements of a packaged embodiment 900 of the current invention. Shown in this embodiment are a near-IR laser source 902, beam formatting optics 904 to stabilize the power and shape the output beam, as well as a rangefinder module 906. In addition, an electrical driver 910 capable of the higher current required by the 10 W diode is provided based on the existing driver design. These integrated elements are provided in a package housing 912.

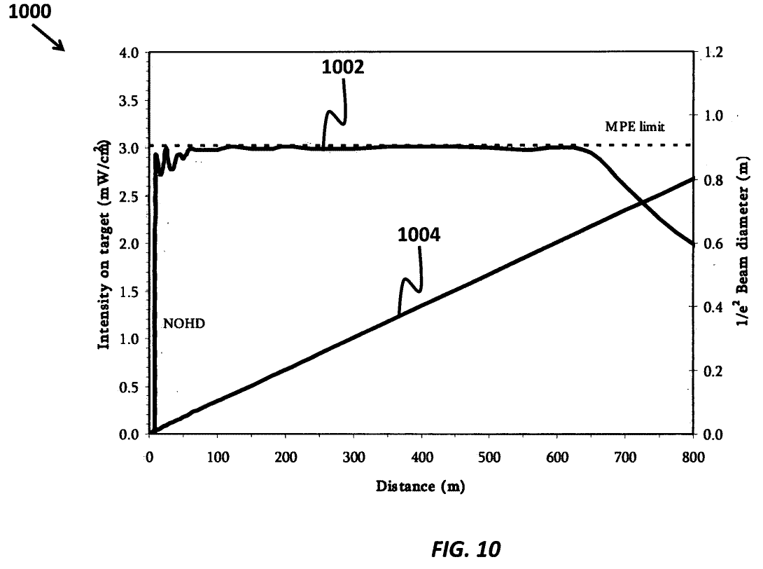

FIG. 10 shows the intensity on a target as a function of distance 1002 and the spot diameter 1004 for a fixed divergence beam with adjustable output power. According to the embodiments discussed above, the built-in rangefinder and laser divergence/power control maintain constant output intensity (˜3 mW/cm²) on the target while meeting ANSI eye-safety limits at all distances beyond 10 meters (dotted line). This scenario produces the desired 0.5 m diameter spot at 500 m range. Beyond 650 m, the intensity drops below 3 mW/cm² because in this embodiment the total output power is limited to 10 W.

According to another aspect of the invention, the laser source can be an infrared multimode laser diode at 810, 830, 880, 905, 915, 940, 976, 1040, 1050, 1064, 1080, 14xx, or 15xx nm. The laser can instead be a DPSS laser at 266, 355, 532, or 1064 nm, an infrared fiber laser at 10xx nm, 14xx nm, 15xx nm, 1.x μm, or 2.x μm. Other laser types include an SE-DFB laser at 905, 915, 940, 976, 1040, 1050, 1064, 1080, 14xx, or 15xx nm.

In another embodiment, the disruption source can be a white light source, which can include a green DPSS micro-laser, red laser semiconductor diode, blue laser semiconductor diode all combined to form a single, white-light source with a controlled divergence and/or power. This embodiment may use spectral, polarization, or spatial combining methods to combine the laser power. The laser power of each wavelength source may range from below 10 mW to over 20 Watts.

In another aspect of the invention, the rangefinder laser source can be a Surface-Emitting Distributed Feedback (SE-DFB) laser at 905, 915, 940, 976, 1040, 1050, 1064, 1080, 14xx, or 15xx nm.

According to other aspects of the invention, further embodiments can include of any of the above elements when combined with one or more additional laser or non-laser light sources in the same housing. The laser or non-laser light sources can include LED, Xenon, halogen, traditional filament flashlight, IR pointer at nominal 830 nm (narrow beam), IR illuminator at nominal 830 nm (wide beam) or visible laser pointer at 635 or 532 nm.

In a further aspect of the invention the green (532 nm) output beam can be adjusted to a collimated and low power (nominal 5 mW) to act as a traditional spotting or pointing laser.

According to one aspect the power source is remotely located (in a separate housing).

In a further aspect, the system is mounted on a gimbal-stabilized platform.

All the aforementioned embodiments are useful for at least one application that includes, dazzling or optical disruption of an assailant, target or battlefield illumination, a vehicle-mounted (truck, car, airplane, ground robot, UAV) application, crowd control, vehicle checkpoints, convoy security, or suppression of combatants or non-combatants. The applicable distances for these applications range from less than 10 meters (close-quarters combat) to long-range (up to 10 kilometers).

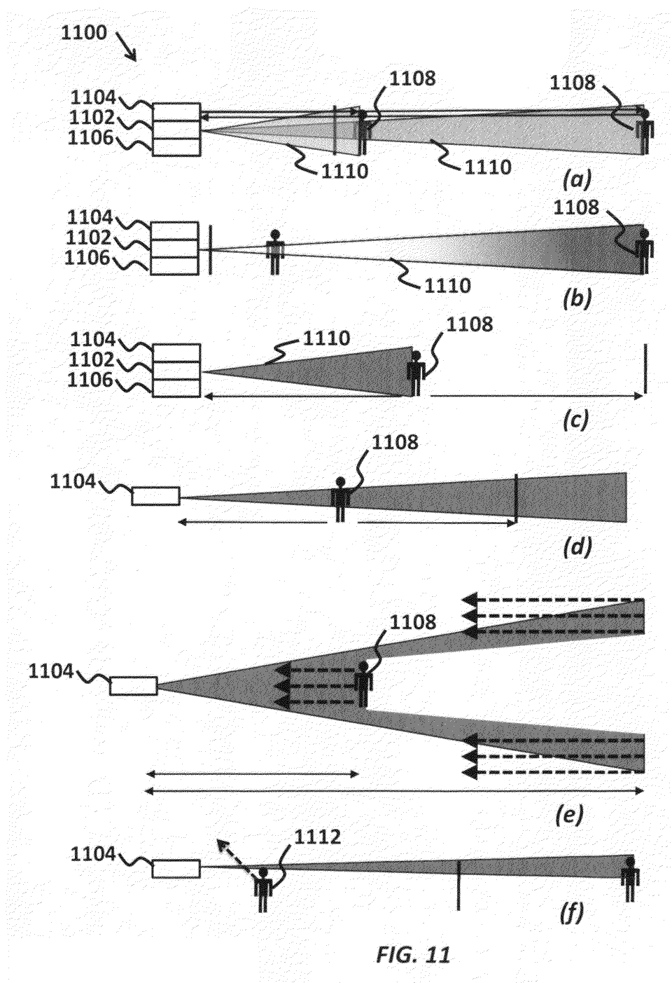

The current invention provides a solution for the problems of laser safety, as well as to increase the usable range for the illuminator. According to one embodiment the irradiace [W/cm²], is controlled by increasing the beam divergence and therefore the illuminated area at the target. The result is a constant beam diameter at different locations with a constant irradiance, as shown in FIGS. 11a-f where shown are the illuminator 1102, the divergence and or power control system 1104, a rangefinder 1106, a target 1108 and the output beams 1110. In another aspect of the invention, an output beam 1110 having a fixed divergence is used while controlling the power of the laser to reduce the power to a level of a safe exposure. This safe level can be defined as within the 0.25-second time window for unintentional beam viewing as shown in FIG. 11b or the 10-second window for extended/internal viewing.

In some cases, the usable range of the illuminator 1102 may exceed the maximum range of the laser range finder 1106. To maximize the usable safe distance of the laser illuminator 1102, one aspect of the invention assumes that if there is no target distance returned from the rangefinder, it must be beyond the maximum range of the rangefinder. In this case, the power of the illuminator 1102 would be set to minimum or the divergence would be increased to the largest possible value to ensure eye-safety, as in FIG. 11c.

In a different embodiment, to ensure effectiveness of the illuminator even if the rangefinder malfunctioned or target is too dark to ensure a return signal, the illuminator could be set to maximum power and/or minimum divergence. However, in this embodiment, the ensured/unconditional operation of the illuminator would have to be balanced against the significant reduction in eye safety assurance. This is shown in FIG. 11d. If the illuminator 1102 were to be set to maximize the output for a long distance target, this illuminated target 1108 would be exposed to a power larger than the MPE that can lead to permanent irreversible ocular damage.

According to the invention, the usable range of the illuminator 1102 can't exceed the maximum range of the range finder 1106, further, without a valid target, the illuminator 1102 will not operate or adjust to minimum mode of operation for maximum safety. For example, in the event the rangefinder 1106 doesn't get a correct reading or generates an error condition, the illuminator 1102 is instructed to deliver a minimum amount of power (and/or maximum divergence) to ensure that the system provides only the maximum permissible exposure (MPE) at a fixed and known unconditional NOHD. This ensures that the system is safe in all cases, even that of potential subsystem failure, and produces a known, fixed minimum NOHD. This fixed minimum unconditional NOHD is much lower than that of a fixed power/divergence system, rendering it much safer and operational overall a much wider range of distances. This is illustrated in FIG. 11c. In another embodiment, the output exit aperture of the device is sufficiently large that the unconditional NOHD is 0 meters.

According to another aspect of the invention, a software program is provided to evaluate the plausibility of the target 1108. For example, with the typical divergence of a laser range finder around 1 mrad, the spot size of the ranging beam will be approximately 25 cm in diameter after a distance of 250 m. If the target 1108 is smaller than the full beam of the range finder 1106 and a reflection of a more distance target, or a more distant one with higher albedo, this might result in a stronger signal to the range finder as shown in FIG. 11e. The illuminator 1102 output should be limited to the closest target 1108 to ensure eye safety.

In order to provide unconditional eye-safety, the laser 1102 needs to be turned off (or adjusted for power and/or divergence) in the event of a person walking through the beam. FIG. 11f shows a person 1112 accidentally passing the line of sight to the target 1108. A similar situation can be produced in the case of a dramatic target distance change. Rapid response of the rangefinder and by the divergence and/or power control is needed to ensure maximal eye safety, including within the 0.25 second unintentional viewing interval. With the active control of the current invention and the rapid response time of the elements involved, this time can be reduced to below the reaction time of the target.

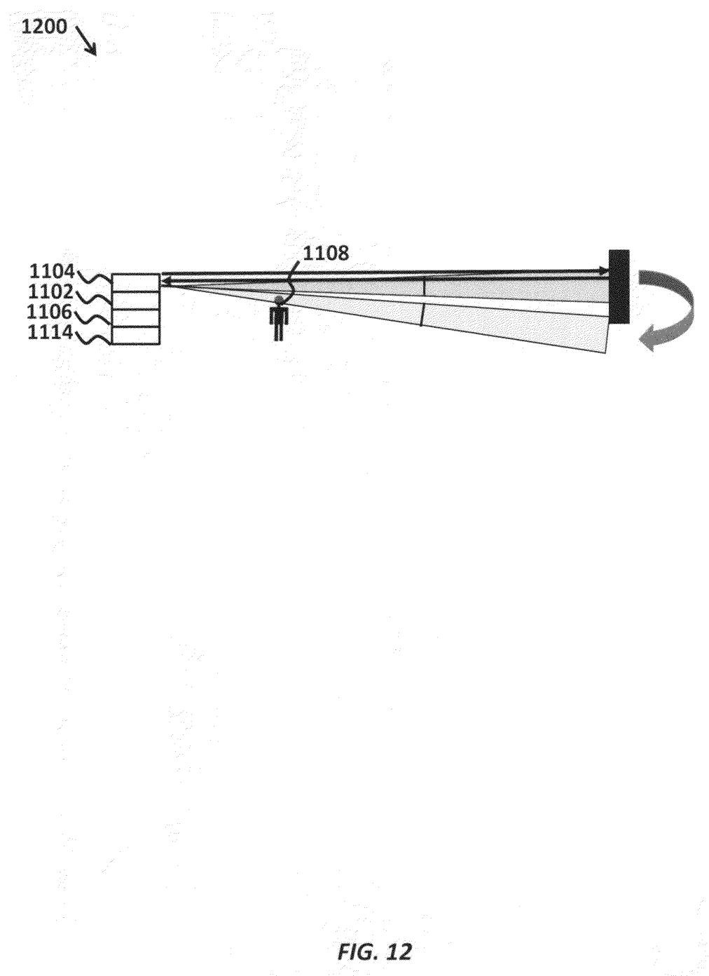

There is a similar problem to the walk-in discussed above, such that when the operator aims at a far distance target 1108, the system will not be able to react to a quick change in the angle of the device rapidly enough, as shown in FIG. 12. The MPE could exceed the allowed limit depending on the distance from the original target to the accidentally illuminated person. To prevent this from happening accidentally or intentionally, the current invention measures accelerations or change in orientation to turn off the laser or set it to the minimum NOHD (minimum power or maximum divergence) for rapid angle changes. This is done by providing an acceleration sensor or miniature gyroscope 1114 to measure angle or orientation changes.

The software control algorithms can be set to respond only to a certain range of accelerations or changes in orientation to ensure that only unintentional motion of the device results in a change in output; in this fashion, the normal accelerations and changes in orientation germane to tactical and operational use will not affect this output. In one embodiment, only a limited range of acceleration change [g/s or m/s³] results in reduction of output irradiance. In another embodiment, only a limited range of orientation change [degrees/s or degrees/s²] results in reduction of output irradiance. In yet another embodiment, acceleration and orientation change are both used to discriminate between unintentional and intentional motion of the device and limit the cases wherein the output irradiance is reduced, ensuring maximal safety but also maximal tactical usability.

Hitting a highly reflective surface could cause the rangefinder 1108 to acquire a distance to a virtual object in the mirrored beam path. The resulting power or divergence could exceed the MPE if the operator sweeps the beam into a direct back reflection for the duration of the system response time. Additionally, weather and environmental effects like rain or smoke may make it challenging or impossible for the rangefinder 1108 to acquire a target distance. The light from the rangefinder pulse will be reflected or scattered in the atmosphere. As discussed earlier, the usable range of the illuminator 1102 can't exceed the maximum range of the rangefinder 1106, and without a valid target, the illuminator 1102 will not operate or is adjusted to minimum irradiance for maximum safety. The worst-case scenario would be that the rangefinder 1106 reports a close target and the laser 1102 turns on with maximum divergence or minimum power.

All dual aperture laser range finders suffer from the same problem: if either the receiving or the transmitting aperture is blocked, the detector will not be able to measure the reflected light from the ranging pulse. Again, the usable range of the illuminator 1102 can't exceed the maximum range of the rangefinder 1106, and without a valid target, the illuminator 1102 will not operate or is adjusted to a minimum for maximum safety.

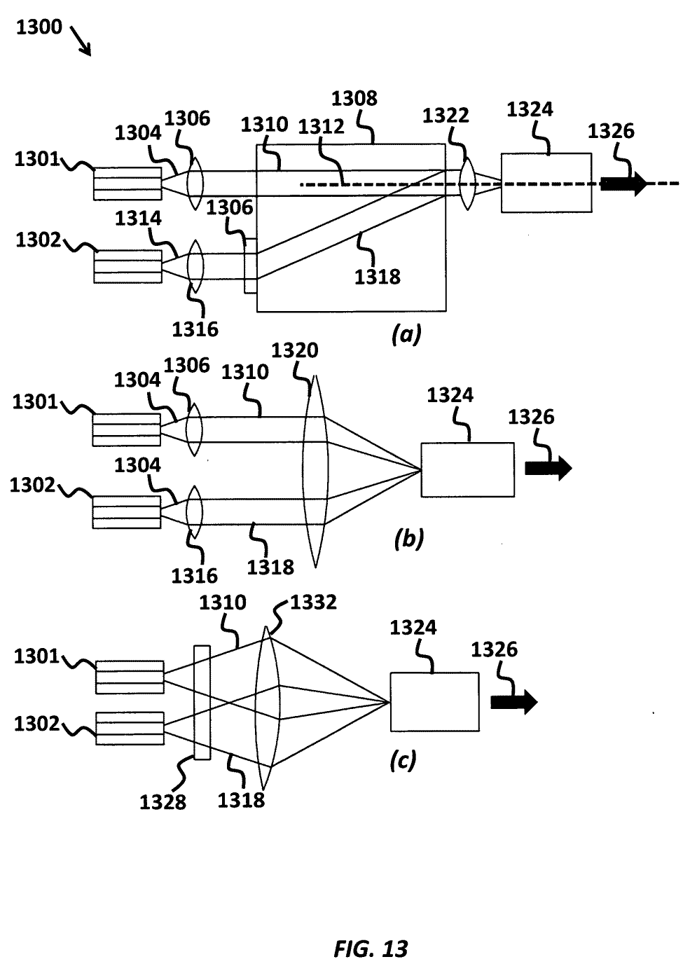

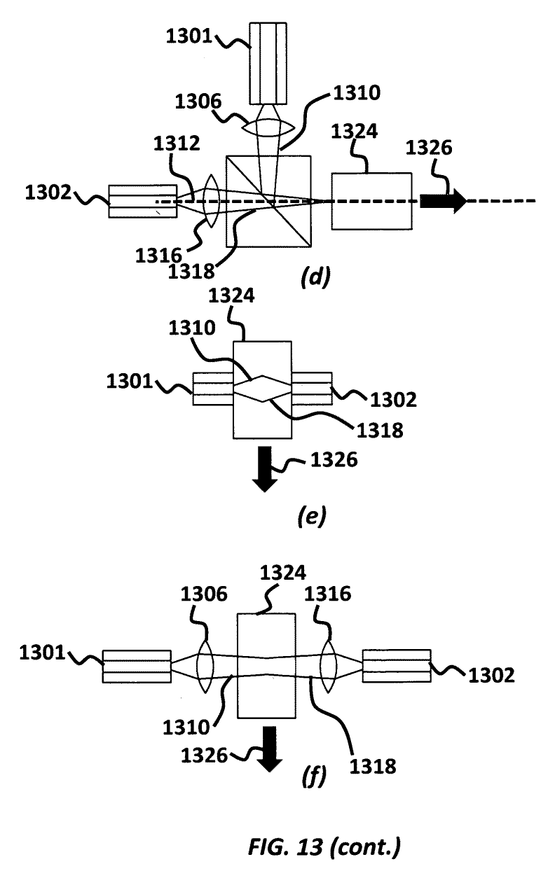

The free-space delivery optics 1300 discussed above are shown in FIGS. 13a-f and provide compact and rugged free-space delivery optics 1300 to pump the solid-state laser medium with improved efficiency and reduced cost to generate the laser system output. FIG. 13a shows at least two wavelength-stabilized diode pump lasers 1301/1302 directing output beams 1304/1314 through a converging lenses 1306/1316, where the converging lenses 1306/1316 from the output beams 1304/1314 through a birefringent crystal 1308. As shown, the birefringent crystal 1308 receives a first pump beam 1310 along an axis of the solid state laser medium 1312 and receives a second pump beam 1318 parallel to the first pump beam 1310, wherein the first pump beam 1310 has a first polarization and the second pump beam has a second polarization. As shown the second polarization is disposed to converge the second pump beam 1318 to the first pump beam 1310 as the pump beams 1310/1318 traverse the birefringent crystal 1308. The birefringent crystal 1308 can be made from material such as calcite, YVO₄, crystalline quartz, or LiNbO₃. Further shown is an optical retarder 1306, such as a wave-plate, where the optical retarder 1306 is disposed along the output beam path of the second diode pump laser and between the second diode pump laser and the birefringent crystal 1320, which provides a compatible polarization of the second pump beam 1318 with the birefringent crystal 1308 for proper convergence. The pump beams 1310/1318 are combined at the output of the birefringent crystal 1308 and pass through a pump beam converging lens 1322 to pump the solid-state laser medium 1324 and generate the laser system output beam 1326.

FIG. 13b shows the free-space delivery optics 1300 having a first converging lens 1306 disposed in an output beam 1304 of a first diode pump laser 1301, a second converging lens 1316 disposed in an output beam 1316 of a second diode pump laser 1302, a third converging lens 1320 is disposed between the first and second converging lenses 1306/1316 and the solid-state laser medium 1324 and generate the laser system output beam 1326 having near-perfect beam overlap.

FIG. 13c shows the free-space delivery optics 1300 having a single beam-forming optic 1328 disposed in the output beams 1304/1314 of the at least two wavelength-stabilized diode pump lasers 1301/1302 directing the pump beams 1310/1318 through a converging lens 1332 to direct the pump beams 1310/1318 to pump the solid-state laser medium 1324 and generate the laser system output beam 1326.

FIG. 13d shows the free-space delivery optics 1300 having a polarizing beam combiner 1334, that receives a first pump beam 1310 along an axis of the solid-state laser medium 1312 and receives a second pump beam 1318 at an angle normal to the axis of the solid-state laser medium 1312, where the first pump beam 1310 has a first polarization and the second pump beam has a second polarization. As shown a first converging lens 1306 is disposed between the first diode pump laser 1301 and the polarizing beam splitter 1334 and a second converging lens 1316 is disposed between the second diode pump laser 1302 and the polarizing beam splitter 1334 to pump the solid-state laser medium 1324 and generate the laser system output beam 1326.

FIG. 13e shows the free-space delivery optics 1300 having a first wavelength-stabilized pump diode laser 1301 coupled to the sidewall of the solid-state laser medium 1324 and a second wavelength-stabilized pump diode laser 1302 coupled to the opposing sidewall of the solid-state laser medium 1324 to pump the solid-state laser medium 1324 and generate the laser system output beam 1326.

FIG. 13f shows the free-space delivery optics 1300 having a first converging lens 1306 disposed along a beam path 1310 of a first diode pump laser 1301 and between the first diode pump laser 1301 and the solid-state laser medium 1324, and further having a second converging lens 1316 disposed along a beam path 1318 of a second diode pump laser 1302 and between the second diode pump laser 1302 and the solid-state laser medium 1324, where the diode pump laser beam pump beams 1310/1318 are disposed normal to the solid-state laser medium 1324 on opposite sides of the laser medium 1324 to pump the solid-state laser medium 1324 and generate the laser system output beam 1326.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art.

All such variations are considered to be within the scope and spirit of the present invention as defined by the following claims and their legal equivalents.

What is claimed:

1. An optical disruptor, comprising:
a. a laser system;
b. a rangefinder, wherein said rangefinder provides a real-time distance to a target;
c. control electronics; and
d. dynamically-controlled output optics, wherein said dynamically-controlled output optics are actuated by said control electronics to provide a divergence in real-time of an output of said laser system, wherein said real-time divergence is according to said real-time distance to said target.

2. The optical disruptor of claim 1, wherein said laser system comprises at least two wavelength-stabilized pump laser diodes having laser diode outputs directed through free-space delivery optics to pump a solid-state laser medium to generate said laser system output.

3. The optical disruptor of claim 2, wherein said free-space delivery optics comprise a birefringent crystal, wherein said birefringent crystal receives a first pump beam along an axis of said laser system output and receives a second pump beam parallel to said first pump beam, wherein said first pump beam comprises a first polarization and said second pump beam comprises a second polarization, wherein said second polarization is disposed to converge said second pump beam to said first pump beam as said pump beams traverse said birefringent crystal.

4. The optical disruptor of claim 3, wherein said birefringent crystal is selected from the group consisting of calcite, YVO₄ (vanadate), crystalline quartz, and LiNbO₃ (lithium niobate), MgF₂, sapphire (Al₂O₃), and zircon (ZrSiO₄).

5. The optical disruptor of claim 3 further comprises an optical retarder, wherein said optical retarder is disposed along a beam path of said second diode pump laser and between said second diode pump laser and said birefringent crystal.

6. The optical disruptor of claim 3 further comprises a first converging lens disposed between said first diode pump laser and said birefringent crystal and a second converging lens disposed between said second diode pump laser and said birefringent crystal.

7. The optical disruptor of claim 3 further comprises a converging lens disposed between said birefringent crystal and said solid-state laser medium.

8. The optical disruptor of claim 2, wherein said free-space delivery optics comprise a polarizing beam splitter, wherein said polarizing beam splitter receives a first pump beam along an axis of said solid-state laser medium and receives a second pump beam at an angle normal to said solid-state laser medium, wherein said first pump beam comprises a first polarization and said second pump beam comprises a second polarization.

9. The optical disruptor of claim 8, wherein a first converging lens is disposed between said first diode pump laser and said polarizing beam splitter and a second converging lens is disposed between said second diode pump laser and said polarizing beam splitter.

10. The optical disruptor of claim 2, wherein said free-space delivery optics comprise a first converging lens disposed in a beam path of a first said diode pump laser, a second converging lens disposed in a beam path of a second said diode pump laser, a third converging lens disposed between said converging lenses and said solid-state laser medium and disposed between said second converging lens and said solid state laser medium.

11. The optical disruptor of claim 2, wherein said free-space delivery optics comprise a first converging lens disposed along a beam path of a first said diode pump laser and between said first diode pump laser and said solid-state laser medium, and further comprising a second converging lens disposed along a beam path of a second said diode pump laser and between said second diode pump laser and said solid-state laser medium, wherein said first diode pump laser beam path is disposed normal to said solid-state laser medium and said second diode pump laser beam path is disposed normal to said solid-state laser medium.

12. The optical disruptor of claim 1, wherein said dynamically-controlled output optics comprise at least one electrically-variable or liquid lens, wherein said electrically-variable or liquid lens adjusts said divergence of said laser system output.

13. The optical disruptor of claim 1, wherein said controller electronics comprise a switching buck regulator, and a switching current source and temperature switching circuit.

14. The optical disruptor of claim 1, wherein said control electronics comprises an optical output regulator.

15. The optical disruptor of claim 1, wherein said optical disruptor is battery-powered.

16. The optical disruptor of claim 1, wherein said solid-state laser medium is selected from the group consisting of Nd:YVO₄ (vanadate), Nd:YAG, Yb:YAG, Yb:glass, Er:glass, Nd:YLF, ND:GGG, and Nd:YGdO₄.

17. The optical disruptor of claim 1, wherein an output from said solid-state laser medium is frequency multiplied using a frequency multiplying medium selected from the group consisting of KTP, KTA, KDP, KD*P, LN, LT, BBO, BIBO, cPPLN, sPPLN, cPPLT, and sPPLT or any of their Mg-doped equivalents.

18. The optical disruptor of claim 1, wherein said laser system output is a pulsed mode or a continuous-wave mode.

19. The optical disruptor of claim 1, wherein said laser system comprises an operating temperature over a range of −20° C. to 60° C.

20. The optical disruptor of claim 1, wherein current is provided to at least one said pump laser diode at all times during operation of said laser system.

21. The optical disruptor of claim 1, wherein said pump laser diodes are controlled according to a condition of said laser system output, wherein said laser output condition is sampled and fed back to said controller by an optical sampler and feedback loop.
